(19) United States
(12) Patent Application Publication
(10) Pub. No.: US 2016/0131292 A1
(43) Pub. Date: May 12, 2016

(54) OXYGEN SUPPLY QUICK-CONNECT ADAPTER

(71) Applicant: Specified Medical Technologies, LLC, St. Louis, MO (US)

(72) Inventor: Aaron Decker, Aberdeen, NC (US)

(21) Appl. No.: 14/537,158

(22) Filed: Nov. 10, 2014

(51) Int. Cl. F16L 37/086; F16L 21/08; F16L 21/05

(52) U.S. Cl. CPC F16L 37/086; F16L 21/05; F16L 21/08

(57) ABSTRACT

Disclosed herein are embodiments of an oxygen quick-connect device, that includes a female coupling that has a first end and second end and a bore extending longitudinally through the first and second ends and further includes a biased plunger disposed within the bore of the female coupling and configured to reciprocate within, a seal member disposed on the plunger and configured to seal at a location on the bore of the female coupling, a catch device disposed at a second end of the female coupling body, and means for connecting the female coupling to an oxygen supply source. The device also includes a male insert that has a first end and a second end and a first bore extending longitudinally through the first and second ends and includes a biased plunger disposed within the first bore of the male insert and configured to reciprocate within, a first seal member disposed on the plunger and configured to seal at a location on the first bore of the male insert, a second seal member disposed on the male insert and configured to seal within the bore of the female coupling, and a barbed connection disposed at a second end of the male insert having a second bore extending there-through perpendicular to the first bore of the male insert, wherein the second bore has a diameter that enables the quick-connect device to provide a desired flow of oxygen.

### FIELD

Embodiments disclosed herein relate to oxygen supply systems, and more particularly, to oxygen supply connections.

### BACKGROUND

Medical piped fluid systems in hospitals, and most other healthcare facilities, are used for supplying piped oxygen and other gases (or fluids) from an oxygen source to various parts of a hospital, including standard hospital room (operating, procedure or other rooms) oxygen line outlets. In typical hospital rooms, oxygen outlet(s) are colored green and located near the patient bed or procedure table. Most standard hospital bed rooms have at least two (2) oxygen outlets, and also a yellow outlet that represents “room air.” Intensive care, operating, and other procedure rooms may have multiple oxygen and air outlets that are needed not only for basic respiratory equipment, but also life support machines (e.g., ventilators, cardiopulmonary bypass pumps, etc.). Attached at the outlet, a Thorpe Tube, or other flow-meter, reduces the pressure from bulk storage (at the wall) to “working” pressure (e.g., 50 psi). The Thorpe Tube flow-meter then regulates the flow through the use of knob that is turned counter clockwise or clockwise to achieve the desired flow rate.

Resuscitation or “ambu” bags, face masks, nebulizers, nasal cannulas and other oxygen delivery devices typically have tubing that attaches to a nipple or “Christmas tree” connector on the flow-meter to facilitate connection to the oxygen source. Christmas tree connectors have deep grooved barbs over which the oxygen tubing slides. These connectors facilitate a rapid mechanical connection and disconnection (e.g., push the tubing on or pull the tubing off), by hand, to oxygen sources. Christmas tree connectors have a threaded end that screws onto the flow-meter outlet.

However, rapid connection and disconnection of oxygen tubing from the Christmas tree connectors has long led to excessive oxygen waste. Most notably, even after oxygen tubing is disconnected from the Christmas tree connector, oxygen sources are often left running at various flow rates for hours or even days. Often times this occurs because hospital staff is in a hurry, or simply neglects to turn off the oxygen source. In any event, oxygen continues to bleed for extended periods of time leading to excessive waste. This has been documented over a long period of time and numerous healthcare professionals have expressed a long felt need to control or stop oxygen waste. Oxygen waste in hospitals is widely acknowledged, but, yet to be addressed. A 2010 study found that fifteen (15) operating rooms wasted roughly 19,000 L of oxygen, or about 670 cubic feet, in a five-day span, which extrapolated over a one year period amounted to nearly one million liters in wasted oxygen.

In addition, Christmas tree connectors do not maintain current oxygen flow rates once disconnected. That is, when patients are transferred from location to location (e.g., discharged or leaves the room for testing or other procedure), their flow oxygen rates, if turned off as required, must be reset to proper levels at the new location.

What is needed then is a device to overcome the deficiencies of the prior art and address these long felt needs.

### SUMMARY

Embodiments described herein overcome the deficiencies and disadvantages of the prior art described above. These deficiencies and disadvantages are overcome, for example, by an oxygen quick-connect device, that includes a female coupling and a male insert. The female coupling has a first end and second end and a bore extending longitudinally through the first and second ends and further includes a biased plunger disposed within the bore of the female coupling and configured to reciprocate within, a seal member disposed on the plunger and configured to seal at a location on the bore of the female coupling, a catch device disposed at a second end of the female coupling body, and means for connecting the female coupling to an oxygen supply source. The male insert has a first end and a second end and a first bore extending longitudinally through the first and second ends and includes a biased plunger disposed within the first bore of the male insert and configured to reciprocate within, a first seal member disposed on the plunger and configured to seal at a location on the first bore of the male insert, a second seal member disposed on the male insert and configured to seal within the bore of the female coupling, and a barbed connection disposed at a second end of the male insert having a second bore extending there-through perpendicular to the first bore of the male insert, in which the second bore has a diameter that enables the quick-connect device to provide a desired flow of oxygen. The oxygen quick-connect device only permits oxygen to flow from the oxygen supply source through the female coupling when the male insert is inserted into the female coupling and the second seal member seals within the bore of the female coupling.

These deficiencies and disadvantages are overcome, for example, by a quick-connect insert having oxygen tubing attached thereto, the quick-connect insert configured to be secured by a catch device on a female coupling in fluid communication with an oxygen source. The quick-connect insert includes a cylindrical main body having a longitudinal bore, a first seal member disposed on an outer diameter of a first end of the main body, in which the first end is insertable within the female coupling to form a fluid seal, a circumferential groove on an outer diameter of the first end configured to engage the catch device, a barbed connector extending perpendicular relative to the main body at a second end, and an orifice extending through the barbed connector, and a movable plunger within the longitudinal bore of the main body configured to allow oxygen to flow from the female coupling and through the orifice of the barbed connector when the quick-connect insert is connected to the female coupling.

### BRIEF DESCRIPTION OF THE DRAWINGS

The invention is illustrated in the accompanying drawings wherein,

FIG. 1 illustrates a cutaway view of an embodiment of a disassembled oxygen quick-connect.

FIG. 2 illustrates a perspective view of an embodiment of a disassembled oxygen quick-connect.

FIG. 3 illustrates a cutaway view of an embodiment of an assembled oxygen quick-connect.

FIG. 4 illustrates a perspective view of an embodiment of an assembled oxygen quick-connect.

### DETAILED DESCRIPTION

Currently, hospitals experience a high rate of oxygen waste using Christmas tree connectors to the oxygen flow control. An oxygen disconnect device is disclosed for eliminating waste by shutting off the oxygen flow when an oxygen tube is disconnected. When the oxygen disconnect device is reconnected, oxygen flows at the rate previously set.

The quick-connect device includes a female coupling body having a first end and second end and a bore or opening extending longitudinally through the first and second ends. Generally the female coupling body may be a plastic or thermoplastic material, such as acetal copolymer. The first end includes a connection means (e.g., threaded connection) configured as needed for connecting to other pieces of fluid transport equipment, such as but not limited to a gas or fluid line (e.g., a standard hospital room oxygen line outlet). A first biased plunger is disposed within the bore of the female coupling and is configured to reciprocate longitudinally within. The plunger includes a seal member at a location configured to seal at some location with an inner surface of the bore in a certain position. The second end of the female coupling body includes a catch device slidably mounted within grooves formed in the second end. The catch device is spring-loaded and reciprocates within the grooves. The catch device may be made of a metal material, such as stainless steel.

The quick-connect device includes a male insert having a first end and second end and a first bore or opening extending longitudinally through the first and second ends. The male insert includes a first seal configured to engage and seal within the bore of the female coupling when the male insert is inserted within the bore of the female coupling. A groove is disposed along a length of the male insert and is configured to engage the catch device of the female coupling when the quick-connect device is assembled, as discussed below. A second biased plunger is disposed within the first bore of the male insert and is configured to reciprocate longitudinally within. The plunger may extend beyond the first end of the male insert. The plunger includes a second seal member at a location configured to seal at some location with an inner surface of the first bore in a certain position. The second end of the male insert includes a Christmas tree connector that extends perpendicular from the male insert body. The Christmas tree connector has a second bore that extends therethrough and that is oriented perpendicular to the first bore of the male insert.

The first end of the male insert is inserted into the second end of the female coupling until the catch device engages the groove in the male insert. There is an audible “click” to signal that a proper connection has been established. Upon coupling, the biased plungers in the female coupling and the male insert engage at ends and force each other in opposite directions to unseal from their respective bores and allow fluid communication through the device. To uncouple or disconnect the male insert from the female coupling, the catch device is depressed to disengage the catch device from the groove in the male insert. When disengaged, the biased plungers disengage. The biased plunger in the female coupling engages the seat within the bore and seals the bore to prevent oxygen flow from the female coupling.

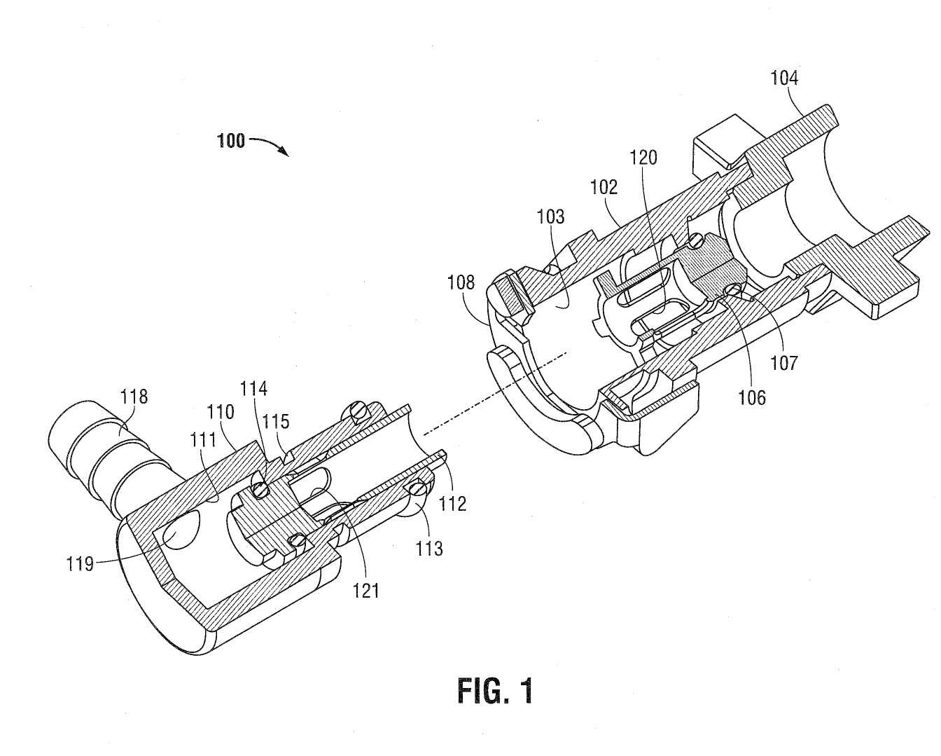

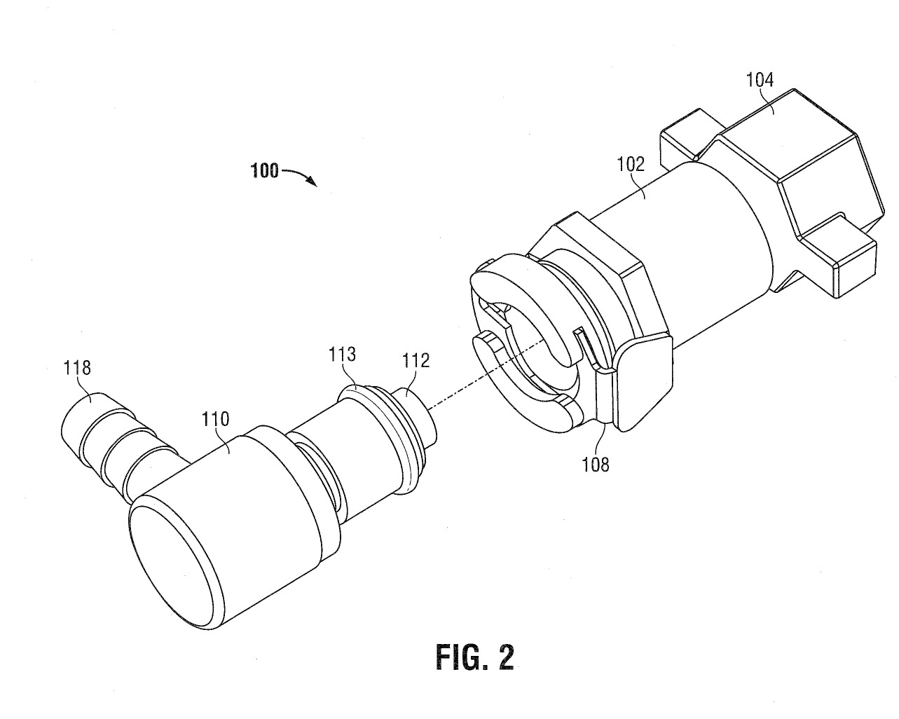

FIGS. 1 and 2 illustrate an embodiment of a disassembled oxygen quick-connect device 100. The quick-connect device 100 includes a female coupling body 102 having a first end and second end and a bore 103 or opening extending longitudinally through the first and second ends. The first end includes a connection means 104 (e.g., a threaded connection) configured as needed for connecting to other pieces of gas or fluid transport equipment (not shown), such as but not limited to a gas or fluid line (e.g., a standard hospital-room oxygen line output). A first biased plunger 106 is disposed within the bore 103 of the female coupling 102 and is configured to reciprocate longitudinally within. The plunger 106 includes a seal member 107 at a location configured to seal at some location (e.g., a seat) with an inner surface of the bore 103 in a certain position. The plunger 106 has a hollow end having a plurality of windows 120 formed in the wall. The second end of the female coupling body 102 includes a catch device 108 slidably mounted within grooves formed in the second end. The catch device 108 is spring-loaded and reciprocates within the grooves. The catch device 108 includes a tab portion that a user may push against and depress in a first direction the catch device against the spring (not shown).

The quick-connect device 100 includes a male insert 110 having a first end and second end and a first bore 111 or opening extending longitudinally through the first end and to the second end. The male insert 110 includes a first seal member 113 configured to engage and seal within the bore 103 of the female coupling 102. A circumferential groove 115 is disposed on the male insert 110, which the catch device 108 of the female coupling 102 engages when the quick-connect device 100 is assembled, as discussed below. A second biased plunger 112 is disposed within the first bore 111 of the male insert 110 and is configured to reciprocate longitudinally within. The plunger 112 may extend beyond the first end of the male insert 110, as shown. The plunger 112 includes a second seal member 114 at a location configured to seal at some location (e.g., a seat) with an inner surface of the first bore 111 in a certain position. The plunger 112 has a hollow end having a plurality of windows 121 formed in the wall.

The second end of the male insert 110 includes a Christmas tree connector 118 that extends perpendicularly from the male insert body 110. The Christmas tree connector 118 includes deep grooved barbs over which the oxygen tubing slides. The Christmas tree connector 118 may be sized accordingly. The Christmas tree connector has a second bore 119 that extends within and that is oriented perpendicular to the first bore 111 of the male insert 110. In embodiments, the second bore 119 typically has a diameter of approximately [0.170″+/−0.001″]. It has been found that this diameter enables the quick-connect device to provide the desired flow of oxygen. It is advantageous to have the Christmas tree connector 118 side-mounted on the male insert 110 for attaching oxygen (or other) tubing and to avoid having the Christmas tree connector 118 advertently broken off when the tubing is attached or removed or simply by being struck when no tubing is attached.

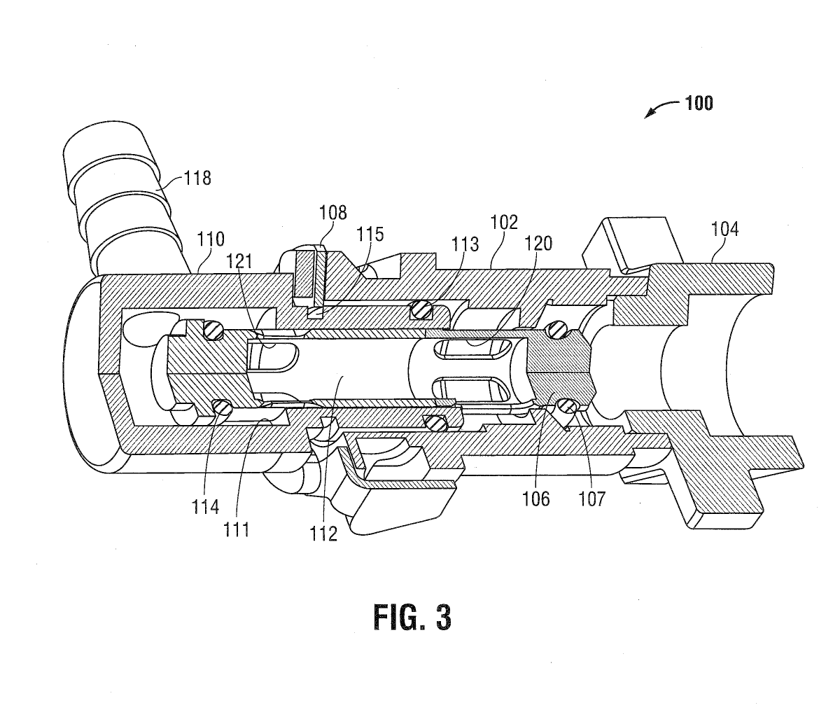

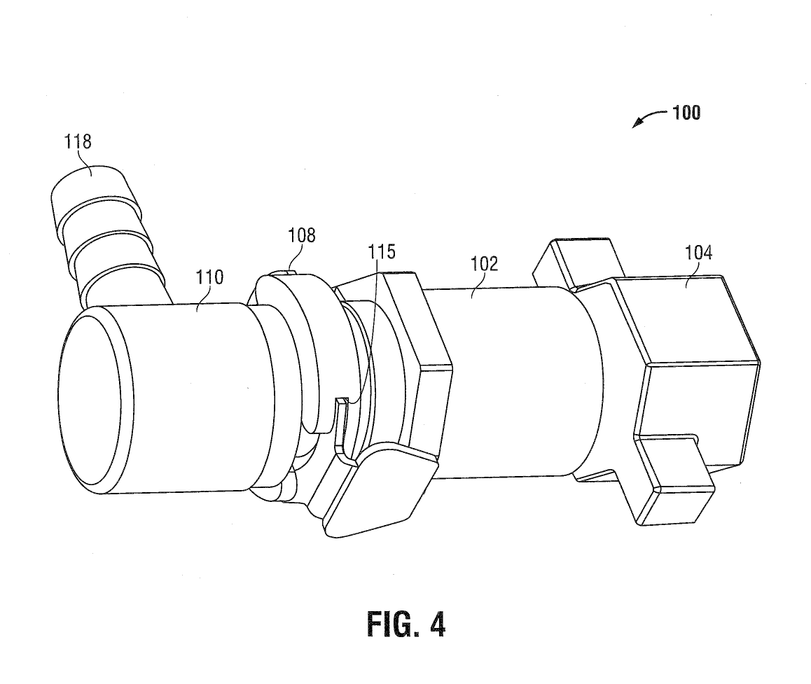

FIGS. 3 and 4 illustrate an embodiment of an assembled or connected quick-connect device. The first end of the male insert 110 is inserted into the second end of the female coupling 102, which is connected to a gas or fluid line (e.g., a standard hospital-room oxygen line output) through connection means 104, until the catch device 108 engages the groove 115 in the male insert 110. There is an audible “click” to signal that a proper connection has been established. The seal member 113 on the male insert 110 engages the inner bore 103 of the female coupling 102 to form a seal. Upon coupling, the biased plunger 106 in the female coupling 102 and the biased plunger 112 in the male insert 110 engage end to end and force each other in opposite directions. Moving the biased plunger 106 in the female coupling 102 unseats seal member 107 from an inner bore 103 surface and moves the plurality of windows 120 into a position to allow gas or fluid to flow into the hollow end of the plunger 106. Likewise, moving the biased plunger 112 in the male insert 110 unseats seal member 114 from a first bore 111 surface and moves the plurality of windows 121 into a position to allow fluid to flow into the hollow end of the plunger 110.

Unseating seal members 107 and 114 substantially together allows gas or fluid communication through the quick-connect device 100. That is, oxygen flows from the oxygen source (not shown), into the female coupling 102, through the plurality of windows 120 into the hollow end of the plunger 106, into the hollow end of the plunger 112, out of the plurality of windows 121, into the male insert 110, and out of the Christmas tree connector 118 to an oxygen delivery device (not shown). To uncouple or disconnect the male insert 110 from the female coupling 102, the catch device 108 is depressed to disengage the catch device 108 from the groove 115 in the male insert 110. When disengaged, the biased plungers 106 and 112 disengage, and seal members 107 and 114 are re-seated within their respective bores to prevent oxygen flow through the quick-connect device 110.

Advantageously, the quick-connect device allows easy “one-hand” connect and disconnect by simply depressing the catch device. The quick-connect device is made of materials that are resistant to chemicals and oxygen. Most importantly, the quick-connect device addresses a long felt need in the medical industry to eliminate oxygen waste by shutting off the oxygen flow when the male insert having oxygen tubing attached thereto is removed from the female coupling. When the quick-connect device is reconnected, the oxygen begins to flow at the rate previously set. In this manner, the desired, previously set oxygen flow rate is maintained. To summarize, when the male insert is not connected to the female coupling, oxygen does not flow; when the male insert is connected to the female coupling, oxygen flows at a consistent rate previously set.

The claimed subject matter is not to be limited in scope by the specific embodiments described herein. Indeed, various modifications of the invention in addition to those described herein will become apparent to those skilled in the art from the foregoing description. Such modifications are intended to fall within the scope of the appended claims.

What is claimed is:

1. An oxygen quick-connect device, comprising:
a female coupling having a first end and second end and a bore extending longitudinally through the first and second ends, the female coupling further comprising:
a biased plunger disposed within the bore of the female coupling and configured to reciprocate within;
a seal member disposed on the plunger and configured to seal at a location on the bore of the female coupling;
a catch device disposed at a second end of the female coupling body; and
means for connecting the female coupling to an oxygen supply source; and
a male insert having a first end and a second end and a first bore extending longitudinally through the first and second ends, the male insert further comprising:
a biased plunger disposed within the first bore of the male insert and configured to reciprocate within;
a first seal member disposed on the plunger and configured to seal at a location on the first bore of the male insert;
a second seal member disposed on the male insert and configured to seal within the bore of the female coupling; and
a barbed connection disposed at a second end of the male insert having a second bore extending therethrough perpendicular to the first bore of the male insert, wherein the second bore has a diameter that enables the quick-connect device to provide a desired flow of oxygen;
wherein the oxygen quick-connect device only permits oxygen to flow from the oxygen supply source through the female coupling when the male insert is inserted into the female coupling and the second seal member seals within the bore of the female coupling.

2. The quick-connect device of claim 1, further comprising a plurality of windows in hollow ends of both biased plungers.

3. The quick-connect device of claim 1, wherein the catch device is slidably mounted within grooves disposed at the second end of the female coupling body.

4. The quick-connect device of claim 1, further comprising a circumferential groove on the male insert configured to engage the catch device.

5. The quick-connect device of claim 1, wherein the connection means is configured to connect the female coupling to a standard hospital room oxygen flowmeter.

6. A quick-connect insert having oxygen tubing attached thereto, the quick-connect insert configured to be secured by a catch device on a female coupling in fluid communication with an oxygen source, the quick-connect insert comprising:
a cylindrical main body having a longitudinal bore;
a first seal member disposed on an outer diameter of a first end of the main body, wherein the first end is insertable within the female coupling to form a fluid seal;
a circumferential groove on an outer diameter of the first end configured to engage the catch device;
a barbed connector extending perpendicular relative to the main body at a second end, and an orifice extending through the barbed connector; and
a movable plunger within the longitudinal bore of the main body configured to allow oxygen to flow from the female coupling and through the orifice of the barbed connector when the quick-connect insert is connected to the female coupling.

7. The quick-connect insert of claim 6, wherein the oxygen tubing removably attached to the barbed connector is attached at an opposite end to an oxygen delivery device.
